(19) United States
(12) Patent Application Publication
(10) Pub. No.: US 2012/0207933 A1
(43) Pub. Date: Aug. 16, 2012

(54) Method for Preparing Inorganic Resins on the Basis of Hydrogen-Free, Polymeric Isocyanates for Preparing Nitride, Carbide and Carbonitride Networks and Use Thereof as Protective Coatings

(76) Inventors: Carsten Ludwig Schmidt, Saarbrucken (DE); Martin Jansen, Leonberg (DE)

(21) Appl. No.: 13/384,662

(22) PCT Filed: Jul. 21, 2010
(86) PCT No.: PCT/EP2010/060572

§ 371 Date: Apr. 24, 2012

(30) Foreign Application Priority Data
Jul. 21, 2009 (DE) 10 2009 034 090.4

(51) Int. Cl. B05D 3/02; C08G 77/00

(52) U.S. Cl. 427/372.2; 528/23

(57) ABSTRACT

The present invention relates to methods for producing inorganic resins, comprising the polymerisation of at least one hydrogen-free, inorganic isocyanate which may be converted into a pure, hydrogen-free polymer by CO₂ abstraction, to resins which are produced by this method, and to the use of such resins for producing coatings.

The present invention relates to methods for producing inorganic resins, comprising the polymerisation of at least one hydrogen-free, inorganic isocyanate which may be converted into a pure, hydrogen-free polymer by CO₂ abstraction, to resins which are produced by this method, and to the use of such resins for producing coatings.

“Resins” are natural or synthetic mixtures of substances of an organic or inorganic nature, the formation of which involved polymerisation (polyaddition or polycondensation) reactions (R. Houwink, Physikalische Eigenschaften und Feinbau von Natur- und Kunstharzen [physical properties and fine structure of natural and synthetic resins], Akademische Verlagsgesellschaft, Leipzig, 1934). Resins are mainly vitreous-amorphous and are distinguished by insolubility in many solvents. Solutions of resins in suitable solvents or sols of resins in suitable dispersants are also known as “coating materials”.

A fundamental distinction is drawn between natural and synthetic resins. Natural resins are primarily excreted by plants and in some cases also by animals. From the very earliest times, these natural substances (for example mastic, dammar, copal, rosin, turpentine, gamboge and shellac) have been used for providing protective coatings, glues, varnishes and plastic masses. The limited and somewhat unsatisfactory profile of properties of this family of substances (thermal and chemical resistance, light-fastness, weathering resistance etc.), combined with limited options for varying the chemical fine structure of the resins, soon led to efforts to seek out alternatives.

Thanks to the systematic studies carried out by Staudinger, Meyer and Mark, the chemical and physical nature of (organic) resins is well understood, so facilitating the investigation of suitable systems or transfer in the field of inorganic resin research (H. Staudinger, Die hochmolekularen organischen Verbindungen [high molecular weight organic compounds], Springer Verlag, 1960; K. H. Meyer, Makromolekulare Chemie [macromolecular chemistry], Akademische Verlagsgesellschaft, Leipzig, 1953). Using the terminology of polymer chemistry, resins may be regarded as three-dimensional macromolecules which may be prepared by homopolymerising or copolymerising suitable monomers.

Because there are accordingly a large number of industrial raw materials which are in principle capable of forming resins, a huge diversity of different synthetic resins are now known (J. Scheiber, Chemie and Technologie der künstlichen Harze [chemistry and technology of synthetic resins], Wissenschaftliche Verlagsgesellschaft, Stuttgart 1961). In fact, the term “resin” nowadays tends to describe a state which prevails whenever “solid solutions”, “solid solvates”, networks or gels and the like are present. This encompasses known organic synthetic resins, together with conventional silicone resins and purely inorganic systems (Cl₂PN, phosphorus nitrile chloride, “inorganic rubber”).

In particular, the use of inorganic, polymeric (hetero-) siloxanes and the associated oxide sol-gel process has significantly expanded the range of available coating materials based on inorganic polycondensation products. Due to the particular emphasis on the colloidal state of the resin sols, the term “nanocoatings” has become established.

Copolymerisation of inorganic and organic monomers gives rise to the class of substances of “hybrid” materials, which are also known as “organically modified glasses” or “organically modified ceramics” (H. Schmidt, J. Non-Cryst. Solids, 1989, 112, 419f).

In recent years, basic research into further inorganic resins has proved extraordinarily fruitful. This should in particular be considered against the background of increased demand for thermally and mechanically stable protective layers. In addition to the extremely promising investigations into the Si—C—N—(H) system (H. Lang, G. Wötting, G. Winter, Angew. Chem. 1991, 103, 1606f), thermosets in the quaternary Si—B—N—C—(H) system (H.-P. Baldus, M. Jansen, Angew. Chem. 1997, 109, 338 ff) may in particular be considered a logical further development. These high polymers, which are classed as amorphous inorganic networks, should be regarded in this respect as intimate copolymers of Si₃N₄, BN, SiC, B₄C and graphite. They are distinguished by elevated hardness and excellent thermal stability. These thermosets, which should be considered structurally homogeneous, resist phase separation/crystallisation up to relatively high temperatures, as, with regard to primary valencies, they are linked by covalent chemical bonds. Reversal of this formation reaction (polymerisation) consequently only proceeds at extremely high temperatures (chemical bond breakage). The networks are broken up into fragments and ultimately form composites of the corresponding thermodynamically stable carbides and nitrides.

It is known that phase separation kinetics are highly dependent on the presence of suitable quantities of carbon. Using the terminology of F. Habers, both the “rate of precipitation” and the “rate of ordering” of the networks is strongly influenced by carbon. The reduction in the degree of dispersion of the colloidal domains in the Si—B—N—C resin as a function of temperature is thus heavily dependent on the fine structure of the networks, which may be decisively influenced by the selection of the starting components.

The synthesis of homogeneous copolymers in the Si—B—N—C—(H) system has been set down in various patents.

The first copolymer of the nominal formula “SiBN₃C” was described by Wagner, Jansen and Baldus in EP 502399 (1992). The underlying reaction pathway involves reacting suitable one-component precursors (for example Cl₃Si—N(H)—BCl₂, TADB) with various amines and ammonia. In addition to the macromolecule, the ammonium base NH₄Cl is also formed. The initially formed polyamides are converted by high temperature thermolysis into nitride resins. Various thermolysis gases, in particular hydrogen, are formed.

Improved physical properties of the networks were set down in WO 98/45302, where the one-component precursor Cl₂Si—CH(CH₃)—BCl₂ (TSDE) was reacted with amines or ammonia. In this case too, a polyamide network is initially formed, from which the hydrogen must be removed at very high temperatures (>1100° C.)

While the ratio of Si, B, N and C atoms is indeed varied in WO 98/45303, these embodiments do, however, always contain hydrogen-containing groups (C—H, N—H).

Hydrogen-containing starting materials are likewise reacted with hydrogen-containing reactive gases in WO 02/22522.

While the method is indeed distinguished by being performed continuously and thus efficiently, the network nevertheless still has to be heated to 1400° C. in order to ensure close-meshed crosslinking.

WO 02/22624 discloses resin mixtures optimised for spinning into fibres. However, in this case too, the starting materials contain hydrogen. 1500° C. is stated as the upper pyrolysis temperature.

Patent application WO 02/22625 describes a process which was decisively improved with regard to the frequently observed undesired loss of volatile hydrocarbons and the associated unfavourable ceramic yield in the Si—B—N—C—(H) system. Here too, the starting materials are not hydrogen-free.

WO 07/110183 discloses resins with improved brittle fracture behaviour or high-temperature stability.

Various approaches have already been developed with regard to reducing the hydrogen content in inorganic resins.

WO 96/06812 proposes a method which allows the production of networks with a lower hydrogen content by crosslinking suitable carbodiimides. Elemental halides are here reacted with bis(trimethylsilyl)carbodiimide. Since one starting compound necessarily contains C—H groups, the stated hydrogen content of 6 wt. % in the product is understandable. One problematic circumstance is that, according to detailed analysis of the various networks, described for example in the thesis by K. B. Wurm (“Synthese elementorganischer Polymere zur Herstellung nichtoxidischer keramischer Materialien” [synthesis of element-organic polymers for producing non-oxide ceramic materials], University of Stuttgart thesis, 1998) numerous impurities, in particular chlorides (with PCl₃: 7%, with AlCl₃: 21%, with BCl₃ 30%) may be detected.

The same approach is taken in WO 98/35921. Published IR data unambiguously indicate the presence of undesired C—H functions (for example bands at 2955 cm⁻¹). Contamination by Si, O and halides are demonstrated by means of various probes.

One problem with the latter two methods is that the carbodiimide groups (R—N═C═N—R′) are capable only with difficulty of interacting with a substrate and thus good adhesion, which is a fundamental requirement for a potential coating material, can hardly be expected.

The carbodiimide function, which acts as a bridging ligand in these networks, is as expected only capable of relatively weak “side-on” interaction with reactive groups on the substrate surface. The structural prerequisites for efficient interaction (for example chemisorption) are absent.

WO 96/23086 accordingly proposes a method for overcoming these disadvantages and applying ceramic layers onto substrates. The proposed processes are, however, all distinguished by elevated complexity, high costs and inadequate reaction control. The substrates must accordingly be pretreated in a suitable but not precisely specified manner, so that the substrate surface can serve as a heterogeneous nucleus. Moreover, the substrates must first be provided with suitable functional groups, for example element-Cl groups. A process which dispensed with such preliminary work would be desirable.

In addition, due to the given molecular size (anisotropy, length) of the carbodiimide function (N═C═N) and its function as a bridging ligand during crosslinking, a three-dimensional macromolecule with relatively large “meshes” is to be expected. According to current theories, it is however known that thermal excitation and decomposition proceed substantially more readily and at substantially lower temperatures with larger meshes (K. Überreiter, Angew. Chem. 1953, 65, 121f). Elevated thermal and mechanical stability is consequently not to be expected.

As is in summary clearly evident from the prior art, there is to date no known suitable coating material based on nitride networks which is obtainable via completely hydrogen-free inorganic resins.

This is a significant disadvantage, since relatively high temperatures are required in order to provide a dense three-dimensional network. The desire is, however, precisely to form a maximally large and dense network by suitable process control at the lowest possible temperatures. It is the tightness of the resultant network which defines the hardness of the layer and its protective function with regard to the coated substrate.

It has been reported that removal of the hydrogen is not completed until temperatures of >1300° C. are reached. Other sources have even reported temperatures of up to 2000° C. In addition to the unfavourably high energy consumption and the exposure of the substrate to excessive temperature (scaling in the case of steels), the corrosive influence of the hydrogen formed is also disadvantageous. It is accordingly known that many substrates, but in particular titanium and some steels, lose strength by the incorporation of hydrogen into their grain structure. This type of material fatigue may lead to cracking and embrittlement of the substrate. Such stress corrosion cracking of the substrate is all the more probable, the higher is the compaction temperature. There is no need to provide a more detailed description of the cracking which is likewise possible within the resin layer due to significant gas escape.

On the other hand, suitable reactive groups (N—H, O—H, less so C—H) are, however, often an important prerequisite for maximally efficient adhesion (chemical bonding) to a substrate to be coated. Without good adhesion of the coating material to a substrate, protective action (corrosion protection, tarnish protection, mechanical protection) can hardly be ensured. The internal cohesion of possible composites (for example glass-ceramics, fibre-reinforced composite materials) would also be greatly impaired in the absence of surface interaction.

None of the above-mentioned documents provides any indication of how elevated adhesive strength of corresponding coatings may be achieved while simultaneously overcoming the disadvantages described in the prior art.

The problem thus arises according to the invention of providing a compact inorganic resin or providing a manufacturing method for such a resin, which adheres well to substrates and enables the formation of a dense coating network on a substrate.

The present object was achieved according to the invention by providing a method in which pure, inorganic, hydrogen-free isocyanates are polycondensed to yield a resin. Polycondensation preferably proceeds at relatively high temperatures under protective gas (for example argon or nitrogen). Only gaseous CO₂ is eliminated during the reaction.

Polycondensation may preferably also be carried out in suitable solvents or dispersants, i.e. high-boiling liquid solvents (boiling point >130° C.), ionic liquids, salt melts etc.

Functional groups must be present in the macromolecular coating material which are capable of interacting directly (chemical bond) with the reactive groups of the substrates (in particular O—H-groups).

The absence of hydrogen-containing functionalities (C—H, O—H, N—H etc.) enables complete three-dimensional crosslinking at moderate temperatures without giving rise to the known disadvantages of hydrogen-containing samples. Due to the known favourable characteristics of covalent nitrides, carbides and carbonitrides, the coating material should be produced on this basis. The process control according to the invention is intended to enable efficient crosslinking at comparatively low temperatures, preferably by making use of polycondensation reactions which proceed catalytically.

Methods for demonstrating that the resins produced according to the invention are “hydrogen-free” are known to a person skilled in the art and comprise for example IR, Raman and thermal gas analysis (detection of H-containing groups such as for example H₂, NH₃, H₂O, CH₄, HCN etc.).

In another aspect of the invention, the non-oxide resins provided in this manner may be incorporated into an oxide matrix (fillers). Inorganic hybrid materials which exhibit favourable combinations of properties are thus created.

While purely thermally induced crosslinking is very time-consuming and thus uneconomic, very good results are achieved with suitable catalysts in the method according to the invention for producing resin. One aspect of the invention therefore relates to catalytic polymerisation, in particular catalytic polycondensation, of the inorganic isocyanates in the method according to the invention.

It was utterly surprisingly found that excellent results may be achieved, for example, with the assistance of known catalysts from the family of phosphorus-containing, heterocyclic organic compounds. In principle, however, any catalysts known to a person skilled in the art for chemically linking isocyanates may be used. Several review articles are available on this subject. Molecular representatives of the phospholene class of substances, in particular 1-phenyl-3-methyl-2-phospholene 1-oxide (PMO), are however preferred. The favourable influence of such catalysts, which may be demonstrated with the assistance of time-resolved, semi-quantitative IR spectroscopy on the reaction product (breakdown of the isocyanate band at approx. 2275 cm⁻¹), could not straightforwardly be inferred from the literature. Very large numbers of catalysts are indeed documented for polycondensing pure organic isocyanates, but no catalytic system has become known for inorganic isocyanates. On the contrary, publications are even available which explicitly refer to the unsuitability of tried and trusted organic chemistry catalysts for inorganic systems (W. Neumann, P. Fischer, Angew. Chem, 1962, 74, 801 ff). The results achieved according to the invention are therefore surprising relative to this prior art. The favourable circumstance surprisingly arises that the pathway according to the invention of catalytic polycondensation of inorganic isocyanates gives rises to a relatively high molar mass of the resultant crosslinked resin. This may be demonstrated by comparative MALDI-TOF measurements on isolated products. A degree of oligomerisation of at least 24 is accordingly obtained in the case of Si—C—N resins for the pathway according to the invention. In contrast, Pump and Rochow report that, using their pathway, polycarbodiimides have a degree of oligomerisation of 6-9 (J. Pump, E. G. Rochow, Zt. anorg. allg. Chem., 1964, 330, 101 ff).

Isocyanates which may be considered suitable are in principle any readily available element-isocyanate compounds, but in particular those with elements from the p-block of the periodic table of elements (PTE) and particularly preferably isocyanates of the light nonmetallic elements such as B, C, Si and P. These are prepared using published methods known to a person skilled in the art. One common method, for example, involves reacting suitable halides, preferably chlorides, with silver isocyanate:

SiCl₄+4 AgNCO→Si(NCO)₄+4 AgCl

All isocyanates are moisture-sensitive compounds and are accordingly properly stored and treated. All reactions are preferably carried out under a protective gas such as for example nitrogen. The isocyanates are initially introduced in the purest possible form, quality control in particular proceeding by means of NMR, IR and Raman spectroscopy.

In the preferred embodiment, the inorganic isocyanate, the catalyst and a suitable solvent are initially introduced and heated to reflux.

The ratio of catalyst to isocyanate may be varied within wide ranges, the ratio preferably lying between 1:5 and 1:20, particularly preferably between 1:10 and 1:20.

The solvent, which is preferably a high-boiling (boiling point >100° C.), nonprotic solvent, is selected according to the invention such that both the isocyanate and the catalyst are sufficiently soluble therein. “Sufficiently” should here be taken to mean that, at least at the boiling point of the solvent, both components are soluble. A secondary, but not absolutely mandatory, requirement is that the boiling point of the selected solvent should be no higher than the thermal decomposition point of the initially introduced isocyanates. Reaction control is then simpler as a result. No limits apply to the ratio between solvent and starting material, but the smallest possible volume will be selected for the purposes of economic process control. It has been found, for example, that 20 ml of solvent are sufficient for 2 g of initially introduced isocyanate. Depending on the embodiment, nonprotic, polar solvents, such as for example DMSO, HMPTA, and nonprotic, nonpolar solvents, such as for example xylene, decalin and dodecane, are preferred. The reaction is particularly preferably performed in the nonprotic nonpolar solvents. In suitable cases in which the isocyanate is itself a liquid, it is in principle possible to dispense with a solvent, but this is not preferred. Separation of the catalyst is then more time-consuming.

The catalytic condensation reaction is carried out for several hours with refluxing:

2 R₃Si—NCO (+PMO)→R₃Si—NCN-SiR₃+CO₂

The formation of CO₂ may be monitored visually during the reaction by means of a connected bubble counter. The duration of the test is determined by the selection of the isocyanates, the nature of the catalyst, the selection of the solvent (boiling point) and the quantity ratios of the starting materials. In addition to the formation of gas, progress of the reaction may also be observed from the formation of a gel. The originally clear solution becomes more and more turbid and the viscosity of the solution increases constantly. From a certain point in time, an insoluble solid finally forms which separates from the solution, which is now clear again (syneresis). A further visual observation which may be found is a yellow coloration of the solution which becomes increasingly intense as the reaction continues. While it is in principle possible to isolate the gel state, the reaction is preferably continued until phase separation. This makes it easy to isolate the resultant polymer from the still dissolved catalyst and ensures a product of elevated purity. The moisture-sensitive product is separated from the solvent, washed and dried at room temperature under a vacuum. The washing procedure is preferably carried out with a solvent which mixes with the high-boiling reaction solvent, but does not itself have an elevated boiling point.

The amorphous inorganic resin prepared in this manner is investigated by means of IR and Raman spectroscopy. It is found that, with longer reaction times or higher reaction temperatures, the intensity of the isocyanate band falls and the intensity of the carbodiimide band increases correspondingly.

The decisive realisation of the invention is that at no time during the catalytic crosslinking reaction is the isocyanate function completely degraded. All the provided inorganic resins thus in each case comprise sufficient free isocyanate groups which are capable of bonding chemically with the functional groups of the substrate. The presence of free isocyanate groups, despite the presence of the catalyst, may be concluded from the increasing inflexibility of the network as it forms. This circumstance makes it increasingly difficult for the free isocyanate groups to get closer together. Surprisingly, however, no reaction occurs between the formed carbodiimide function and isocyanate. This reaction is well known in organic chemistry, but would appear to be excluded in the case of inorganic systems. IR spectroscopy did not at any time reveal any indication of such a reaction mechanism. After catalytic crosslinking, the resin may thus be interpreted as a hydrogen-free network of the form

E(NCN)ₓ(NCO)_{y}

(E=element). The x and y ratio depends on the process parameters. It may thus be purposefully influenced and monitored by means of semiquantitative IR spectroscopy. Advantageously, however, the ratio x:y should amount to at least 1:1. The ratio is, however, preferably distinctly larger. Bonding to the substrate preferably proceeds via a urethane bond, according to:

R₁—NCO+H—O—R→R₁—NH—CO—O—R

Another aspect of the invention relates to a resin produced by the method according to the invention. The resin is preferably hydrogen-free and/or preferably comprises both isocyanate groups (—NCO) and carbodiimide/cyanamide groups (—NCN—). In a further preferred embodiment, the resin assumes the form of powders and/or coatings.

A further aspect of the invention relates to a method for producing a coating, comprising the steps
a) application of a resin according to the invention onto a substrate to be coated and
b) thermal treatment of the coated substrate.

For application of coatings onto cleaned and degreased substrates of all kinds (metals, glass and ceramics), the provided resin is preferably mixed with a suitable dispersant or binder. Prior to mixing, the resin powder is mechanically comminuted and screened. Comminution and screening are operations known to a person skilled in the art. Comminution may be achieved, for example, by a grinding operation in a ball mill. The grinding operation is advantageously carried out until the resin powder passes through a screen of a suitable mesh size. Suitable binders for blending a coating compound are familiar to a person skilled in the art, a binder preferably being selected which is completely thermolysed at elevated temperatures without forming carbon-containing residues (no “soot fouling”). One known binder of this kind is for example a polycondensation product prepared from glycerol and phthalic acid which is decomposed at approx. 380° C. without leaving a carbonaceous residue behind.

In an alternative aspect of the present invention, the inorganic resin may, however, also be combined with temperature-stable binders. This provides access to hybrid coating materials. Suitable temperature-stable binders are known, inexpensive compounds such as for example water glass, colloidal silica, polyphosphates, clay and cement (mortar). Customised matrix systems may, however, also be selected. In these cases, the nitride resin is dispersed in the binder and acts as a filler which has a positive influence in particular on the mechanical properties (hardness, abrasion etc.) of the binder matrix.

The ratio of resin to binder may be varied within wide ranges and ultimately only influences the achievable film thickness of the ceramic coating. An addition of up to 30 weight percent relative to the weight of resin has proven advantageous. Additions such as pigments (for example TiO₂, Fe₂O₃), opacifiers (for example SnO₂), anti-flow additives etc. may furthermore be added to the system provided in this manner. Quantities may vary, but it has been found that, relative to the resin, pigment contents of up to 30 wt. %, opacifiers up to 10 wt. % and anti-flow additives up to 7 wt. % provide particularly favourable results. The coating compound or coating material may be applied using any usual surface finishing methods, i.e. brush application, brushing, dipping, spraying and spinning. A spraying process is, however, preferred. In an advantageous embodiment, the coating material is applied by means of a robot-controlled spraying process. The initially introduced coating material is here degassed and subjected to continuous, pump-controlled circulation. The coating material, which thus comprises neither bubbles nor agglomerates, is sprayed directly onto the substrates by means of suitable spray nozzles. The temperature, atmosphere and atmospheric humidity of the spray chamber, and the intrinsic viscosity of the coating material are adjusted to one another. It has accordingly been found that a suitable coating material exhibits a viscosity of 5-12 cP at T=22.2° C. The thickness of the applied films is heavily dependent on the above-stated parameters and may accordingly be varied within wide ranges. Favourable results are obtained with wet film thicknesses of between 5 and 15 μm. Applied film thicknesses of greater than 15 μm increase the probability of cracking, while lower film thicknesses (in particular “nanolayers”) do not exhibit favourable mechanical properties (hardness, abrasion etc.).

The films predried at RT are then subjected to a thermal compaction process. Thanks to the circumstance according to the invention that the resin is hydrogen-free, favourable compaction may proceed at temperatures considerably below T=1000° C. This is a fundamental difference from the systems of the above-stated patents. It has thus been found in the case of Si—C—N resins that catalytic crosslinking at just T=220° C. gives rise to an amorphous-vitreous resin of density 1.56 g/cm³. This value is very close to the result for the crystalline compound “Si(NCN)₂” (silicon carbodiimide), for which a density of 1.52 g/cm³ was calculated on the basis of X-ray photographic data (R. Riedel, A. Greiner, G. Miehe, W. Dessier, H. Fuess, J. Bill, F. Aldinger, Angew. Chem.-Int. Ed., 1997, 36/6, 603-606). Even if the latter-stated value is uncertain, the similarity of the data is indicative of an extremely efficient catalytically controlled crosslinking of the isocyanates. Further thermal ordering or crosslinking proceeds with liberation of thermolysis gases (N₂, CO₂, (CN)₂) and may be studied in DTA-MS investigations carried out in parallel. By further compaction, which ultimately leads to thermal decomposition, a resin film or ceramic film of variable composition SiCₓN_{y} may thus be obtained. The borderline cases are the formula Si(NCN)₂ in the lower temperature range and SiC (silicon carbide) in the upper range. Flexible ceramic compositions may thus be obtained by precise furnace protocols (heating rate, duration, atmosphere). Raman spectroscopy supports the homogeneity of the ceramic copolymers. Up to T>1400° C., neither Si₃N₄, SiC nor free carbon bands can be detected. Only from this temperature does the thermodynamically stable product SiC form (bands at 779cm⁻¹ and 950 cm⁻¹), as may then also be demonstrated by means of powder diffractometry (F-43m, a=4.361 Å). It is clearly evident from the experimental data that a homogeneous, amorphous copolymer is present up to relatively elevated temperatures.

The final formation of porous ceramic carbide layers also falls within the scope of the present invention.

In comparison with the prior art, the production of the carbides by this pathway is distinctly preferred due to the significantly lower temperature of the process (A. Appen, A. Petzold, Hitzebeständige Korrosions-, Wärme- and Verschleiβschutzschichten [heat-resistant corrosion, heat and wear protection layers], VEB Deutscher Verlag fur Grundstoffindustrie, 1980).

In a preferred embodiment of the present application, layers produced according to the invention, in particular carbide, nitride or carbonitride amorphous networks, partially crystalline vitreous ceramics or high performance ceramics may be coated with a further layer. Further additional characteristics may be obtained in this manner, such as for example scratch resistance, corrosion resistance or decorative effects. In a preferred embodiment, this additional coating layer preferably comprises a vitreous layer. Such layers are described for example in DE 197 14 949.

A further aspect of the invention relates to the use of a resin according to the invention for producing a coating as corrosion protection, anti-wear protection and/or oxidation protection with high-temperature stability.

### EXAMPLES

The following examples serve to illustrate the invention and should not be regarded as limiting. Modifications to the processes are known to a person skilled in the art and likewise fall within the scope of the invention.

### Synthesis of the Isocyanates:

SiCl₄+4 AgNCO→AgCl+Si(NCO)₄

Predried AgNCO (produced from KOCN and AgNO₃) is dispersed in absolute toluene and freshly distilled SiCl₄, dissolved in toluene, is added dropwise to the dispersion with stirring (a 10% excess of AgNCO was used). The suspension is heated for 3 h with refluxing. The colour of the suspension changes from colourless to violet-grey. After separation of the solid (AgCl), the solvent is removed under a dynamic vacuum and the remaining pale yellowish liquid is distilled at T=186° C. A clear liquid is obtained. Yield is quantitative.

Analysis: Raman: 1471 cm⁻¹, 618 cm⁻¹, 494 cm⁻¹, 294 cm⁻¹ and 251 cm⁻¹
¹³C-NMR: 122.2 ppm
Melting point: 26° C.

Other element isocyanates (for example B(NCO)₃, P(NCO)₃, Ge(NCO)₄) are prepared in similar manner.

### Synthesis of the Macromolecules/Resins:

A small quantity of the catalyst PMO (0.2 g) is dissolved in 20 ml of dodecane (boiling point: 216° C.) and 2 g of freshly prepared Si(NCO)₄ are added. The clear, colourless solution is heated to reflux for several hours. The separated orange-brown material is isolated, washed with pentane and dried under a dynamic vacuum.

### Analysis: XRD: Amorphous Material

IR: 2275 cm⁻¹ (isocyanate band), 2180 cm⁻¹ (carbodiimide band)
Density: 1.56 g/cm³
MALDI-TOF-MS: highest volatile mass: 2566 m/z
²⁹Si-NMR: 100-110 ppm (broad signal)

Macromolecules with other or further isocyanates are synthesised in similar manner.

### Preparation and Application of the Coating Mixture:

100 parts of resin are mixed with 30 parts of binder and intimately dispersed in one another. This proceeds by alternately treating the batch with a ball mill (for example PM 100, from Retsch) and an ultrasound device (for example Bandelin Sonorex Digitec). Relatively large agglomerates are finally removed from the coating material by a 125 mesh size filter. The coating material is applied by means of a manual spray gun (for example SATA minijet 4 HVLP model) onto a previously cleaned and degreased substrate (1.4301 stainless steel sheet). After initial drying at RT, the wet film thickness is determined at 6 μm.

### Thermal Post-Treatment of the Coated Substrates:

The coated substrates are [heated] in a furnace under a pure nitrogen atmosphere up to a temperature of T =500° C. The heating rate amounts to 3° C./min. This temperature is maintained for 1 h and is then slowly reduced. The ceramic layers prepared are brown in colour. Dry film thickness amounts to approx. 2 μm.

### Analysis: Raman Spectroscopy: No Discernible Bands

XRD: amorphous material
Pencil hardness: >9 H

### Production of Multilayer Systems:

a)

A layer according to the invention is overcoated with a dilute PTFE suspension (60 wt. %, DuPont). Wet film thicknesses of approx. 1 μm are obtained. This topcoat is heated at 2° C./min. to 350° C., maintained at that level for 1 h and cooled.

Hard stable layers are obtained which are additionally strongly water-repellent (hydrophobic) (contact angle relative to water >90°).

b)

A (matt) layer according to the invention is overcoated with a transparent vitreous topcoat. DE 197 14 949 documents formulations for such overcoats.

Wet film thicknesses of up to 6 μm are applied and heated at 2° C./min. to 450° C. The originally matt coating consequently achieves glossy visual properties. The degree of gloss is determined with a glossmeter at a measuring angle of 60° . Degrees of gloss of between 50 and 60 units (relative to 100) are obtained.

1-44. (canceled)

45. A method for producing inorganic resins comprising:
polymerizing at least one hydrogen-free, inorganic isocyanate; and,
converting the polymerized hydrogen-free, inorganic isocyanate by CO₂ abstraction to form a hydrogen-free polymer inorganic resin.

46. The method of claim 45, wherein the inorganic resins form nitride, carbonitride and/or carbide networks.

47. The method of claim 45, wherein the at least one hydrogen-free, inorganic isocyanate may be prepared according to the general formula E(NCO)ₓ, wherein E is any desired chemical element of the periodic table of elements, and x is the number of NCO ligands.

48. The method of claim 47, wherein E is selected from the p-block of the periodic table of elements.

49. The method of claim 47, wherein E is B, C, Si or P.

50. The method of claim 45, wherein the polymerizing of the isocyanate proceeds catalytically.

51. The method of claim 50, wherein the catalyst used is a compound which catalyzes the polycondensation of inorganic isocyanates.

52. The method of claim 50, wherein the catalyst is a heterocyclic phosphorus compound, a phospholene, or 1-phenyl-3-methyl-2-phospholene 1-oxide (PMO).

53. The method of claim 51, wherein the catalytic polycondensation is carried out below the decomposition temperature of the resultant polymer.

54. The method of claim 51, wherein the catalytic polycondensation is carried out in a suitable solvent or dispersant.

55. The method of claim 51, wherein the catalytic polycondensation is carried out in an organic, high-boiling solvent with a boiling point >100° C.

56. The method of claim 51, wherein the catalytic polycondensation is carried out in nonpolar, aprotic solvents.

57. The method of claim 50, wherein the ratio of catalyst to isocyanate is between 1:1 and 1:100, or between 1:5 and 1:20.

58. The method of claim 54, wherein the catalyst and the solvent are separated from the resin.

59. A resin produced according to the method of claim 45.

60. The resin of claim 59, wherein the resin is hydrogen-free.

61. The resin of claim 59, wherein the resin comprises isocyanate groups (—NCO) and carbodiimide/cyanamide groups (—NCN—).

62. A method for producing a coating, comprising the steps of:
a) applying the resin of claim 59 onto a substrate to be coated; and,
b) thermally treating the coated substrate.

63. The method of claim 62, wherein the thermal treatment is carried out at a temperature at or below 2000° C., at or below 1000° C., or at or below 500° C.

64. The method of claim 62, wherein the resin is thermally converted into: an inorganic carbide, nitride or carbonitride amorphous network; an inorganic carbide, nitride or carbonitride partially crystalline vitreous ceramic; an inorganic carbide, nitride or carbonitride crystalline ceramic; or an inorganic carbide, nitride or carbonitride high performance ceramic comprising at least the elements Si, B, N and C.

65. The method of claim 64, wherein the carbide, nitride or carbonitride amorphous network, the partially crystalline vitreous ceramic or high performance ceramic is coated with a further layer.

66. The method of claim 62, wherein the resin used in step (a) is part of a coating system (filler) or is the basis of a coating system.

67. The method of claim 66, wherein the coating system is applied by means of brush application, brushing, dipping, spinning or spraying.

68. The method of claim 66, wherein the coating system is applied with a wet film thickness of at least 1 μm or at least 5 μm.

69. The method of claim 66, wherein the coating system is thermally stoved.

70. The method of claim 66, wherein the coating system is thermally stoved at a temperature at or below 2000° C., or below 1000° C., or at or below 500° C.
